(19) United States
(12) Patent Application Publication
(10) Pub. No.: US 2006/0105215 A1
(43) Pub. Date: May 18, 2006

(54) Novel membrane and membrane electrode assemblies

(76) Inventors: Gangadhar Panambur, Honolulu, HI (US); Arunachala Nadar Mada Kannan, Honolulu, HI (US)

Correspondence Address: DECHERT LLP, P.O. BOX 10004, PALO ALTO, CA, 94303, US

(21) Appl. No.: 10/990,452

(22) Filed: Nov. 16, 2004

(51) Int. Cl. H01M 8/10; C08J 5/22

(52) U.S. Cl. 429/30; 429/33; 521/27

(57) ABSTRACT

An ion exchange membrane for use in an electrochemical cell is described. The ion exchange membrane includes: (i) a first layer capable of conducting ions when placed between two electrodes of the electrochemical cell; and (ii) a second layer disposed around at least a portion of the first layer, wherein the second layer is made from a perimeter strengthening material, such that the second layer strengthens at least a portion of a perimeter boundary of the first layer. Methods for making such ion exchange membranes and methods of making membrane electrode assemblies incorporating such membranes are also described.

### FIELD OF THE INVENTION

The present invention relates to novel membrane electrode assemblies and methods for making the same. More particularly, the present invention relates to novel membrane electrode assemblies that have integrated into them novel ion exchange membranes and also relates to methods for making the same.

### BACKGROUND OF THE INVENTION

With the growing need for energy in the presence of limited fossil fuel supply, the demand for environmentally friendly and renewable energy sources is increasing. Fuel cell technology, a promising source of clean energy production, is the leading candidate to meet the growing need for energy. Fuel cells are efficient energy generating devices that are quiet during operation, fuel flexible (i.e., have the potential to use multiple fuel sources), and have co-generative capabilities (i.e., can produce electricity and usable heat, which may ultimately be converted to electricity). Of the various fuel cell types, the proton exchange membrane fuel cell (PEMFC) is believed to have the greatest potential. PEMFCs can be used for energy applications spanning the stationary, portable electronic equipment and automotive markets.

At the heart of the PEMFC is a fuel cell membrane (hereinafter “ion exchange membrane”), which separates the anode and cathode compartments of the fuel cell. The ion exchange membrane plays a significant role in controlling the performance, efficiency, and other major operational characteristics of the fuel cell. An ion exchange membrane should be an effective gas separator, effective ion conducting electrolyte, have a high proton conductivity in order to meet the energy demands of the fuel cell, and have a stable structure to support long fuel cell operational lifetimes. Moreover, the material used to form the membrane should be physically and chemically stable enough to allow for different fuel sources and a variety of operational conditions.

Currently, commercial fuel cell membranes are formed from perfluorosulfonic acid (PFSA) materials. A commonly known PFSA membrane is Nafion® and is available from DuPont.

Nafion® and other similar perfluorinated membrane materials manufactured by companies such as W. L. Gore and Asahi Glass (described in U.S. Pat. Nos. 6,287,717 and 6,660,818 respectively) show high oxidative stability as well as good performance. Unfortunately, these perfluorinated membrane materials are very expensive to produce and difficult to manufacture, which significantly hinder the economic viability of fuel cells. Currently, perfluorinated membranes such as Nafion(® cost as much as $500 per m². Furthermore, these materials have a limited potential to operate at temperatures above 95° C. because they have a lower softening point (Tg).

To overcome the cost limitations and increase the operating temperature capabilities of PEMFCs, alternative polymer materials have been actively researched. For example, partially fluorinated polymer structures, such as poly(vinyldifluorides) (PVDF) and polystyrene grafted PTFE, hydrocarbon structures such as aliphatic elastomers and aromatic thermoplastics, and non-fluorinated non-hydrocarbon polymer systems like polyphosphazenes and polysiloxanes have been studied. To date, the most promising of the alternative materials have been acid finctionalized aromatic thermoplastics.

Aromatic thermoplastics, such as poly(ether ether ketone) (PEEK), poly(ether ketone) (PEK), poly(sulfone-udel) (PSU) and poly(ether sulfone) (PES) have performed well as fuel cell membranes due to their low cost and good film forming characteristics. When functionalized with sulfonic acid or ion exchange moieties, these materials can be used as fuel cell membranes, as described in the following publications: U.S. Pat. No. 6,465,136; U.S. Pat. No. 6,790,931; U.S. Patent App 20040028976; J. Polym. Sci., Part A, 34, 2421 (1996); J. Appl. Polym. Sci. 61, 1205 (1996); J. Membr. Sci. 139, 211 (1998); Macromolecules 33, 7609 (2000); Electrochem. Acta 46, 2401 (2001); J. Appl. Polym. Sci. 77, 1250 (2000); Electrochem. Syst. 3, 93 (2000); J. Polym. Sci. 70, 477 (1998); Macromolecules 25, 6495 (1992); Solid State Ionics 106, 219 (1998); Solid State Ionics 106, 219-225 (1998); and Solid State Ionics 106, 219 (1998).

Although these materials are inexpensive to produce and in many cases are more tolerable to relatively higher operating temperatures, most of them lack long term stability to offer viable commercial solutions as ion exchange membranes.

What is therefore needed are membrane electrode assemblies that enjoy the advantages of long term stability and commercial viability, without suffering the disadvantages of conventional ion exchange membranes.

### SUMMARY OF THE INVENTION

To achieve the foregoing, the present invention provides inventive ion exchange membranes, inventive membrane electrode assemblies and methods for making the same. The present invention provides an ion exchange membrane for use in an electrochemical cell. The ion exchange membrane includes: (i) a first layer capable of conducting ions when placed between two electrodes of the electrochemical cell; and (ii) a second layer disposed around at least a portion of the first layer, wherein the second layer is made from a perimeter strengthening material, such that the second layer strengthens at least a portion of a perimeter boundary of the first layer.

In one embodiment, an ion exchange membrane of the present invention has a perimeter strengthening material adhering to a perimeter boundary on both sides of the ion exchange membrane. In an alternative embodiment, the ion exchange membrane of the present invention has a perimeter strengthening material adheres adjacent to the edges of the ion exchange membrane.

In another aspect, the present invention provides an ion exchange membrane for use in an electrochemical cell. The ion exchange membrane includes: (i) a first component; and (ii) a second component which includes at least one member selected from a group consisting of filler, porous matrix and a perimeter strengthening material, wherein the first component contains a polymer electrolyte composition which includes at least one type of a polymer repeat unit that has more than one property imparting unit. The property imparting unit includes at least one member selected from a group consisting of a conductivity imparting unit and a stability imparting unit.

In yet another aspect, the present invention provides a process of making an ion exchange membrane. The process includes: (i) preparing a solution of a polymer electrolyte composition including at least one type of a polymer repeat unit having attached thereto more than one property imparting unit, the property imparting unit includes at least one member selected from a group consisting of a conductivity imparting unit and a stability imparting unit; (ii) adding to the solution a performance enhancing component; (iii) casting on a support assembly the solution containing the performance enhancing component; and (iv) drying the solution to form an ion exchange membrane which has dispersed within it the performance enhancing component.

In yet another aspect, the present invention provides a process of making an ion exchange membrane. The process includes: (i) obtaining an ion exchange layer including at least one type of a polymer repeat unit that has more than one property imparting unit, which includes at least one member selected from a group consisting of a conductivity imparting unit and a stability imparting unit; (ii) fabricating around at least a portion of a perimeter of the ion exchange layer a performance enhancing layer to form the ion exchange membrane.

In yet another aspect, the present invention provides a process of making an ion exchange membrane. The process includes: (i) preparing a solution of a polymer electrolyte composition including at least one type of a polymer repeat unit having attached thereto more than one property imparting unit, which in turn includes at least one member selected from a group consisting of a conductivity imparting unit and a stability imparting unit; (ii) impregnating the solution into a porous material; and (iii) drying the solution to form an ion exchange membrane.

### BRIEF DESCRIPTION OF THE FIGURES

FIG. 1 shows primary components of a fuel cell, according to one embodiment of the present invention.

FIG. 2 shows a side view of one embodiment of a membrane electrode assembly (“MEA”) incorporated into the fuel cell of FIG. 1.

FIG. 3 shows a detailed illustration of one embodiment of an inventive ion exchange membrane, which has a filler and is integrated into the MEA of FIG. 2.

FIG. 4A shows a side view of an alternative embodiment of an inventive membrane electrode assembly, which has a perimeter strengthening material adhering to a perimeter boundary on both sides of the ion exchange membrane.

FIG. 4B shows a perspective view of a sub-assembly of ion exchange membrane and perimeter strengthening material of FIG. 4A.

FIG. 5A shows a yet another embodiment of an MEA having incorporated in it a perimeter strengthening material.

FIG. 5B shows a perspective view of a sub-assembly of ion exchange membrane and perimeter strengthening material shown in FIG. 5A.

FIG. 6 shows a yet another embodiment of an inventive MEA of the present invention having a porous matrix.

FIG. 7 shows one embodiment of an polymer electrolyte composition, which is used in part to form an exemplar ion exchange membrane of the present invention.

### DETAILED DESCRIPTION OF INVENTION

The present invention provides electrochemical cell designs and methods for making the same to impart that electrochemical cell with certain desired properties. These designs and methods are particularly useful because they provide the requisite long-term stability and prolong the longevity of the cell. To this end, the present invention offers inventive ion exchange membranes that form novel membrane electrode assemblies (“MEA”).

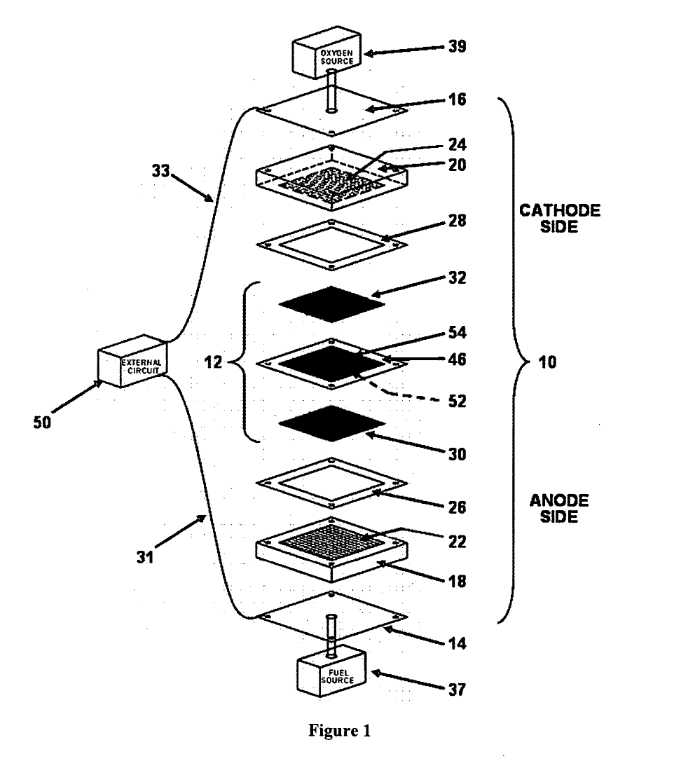

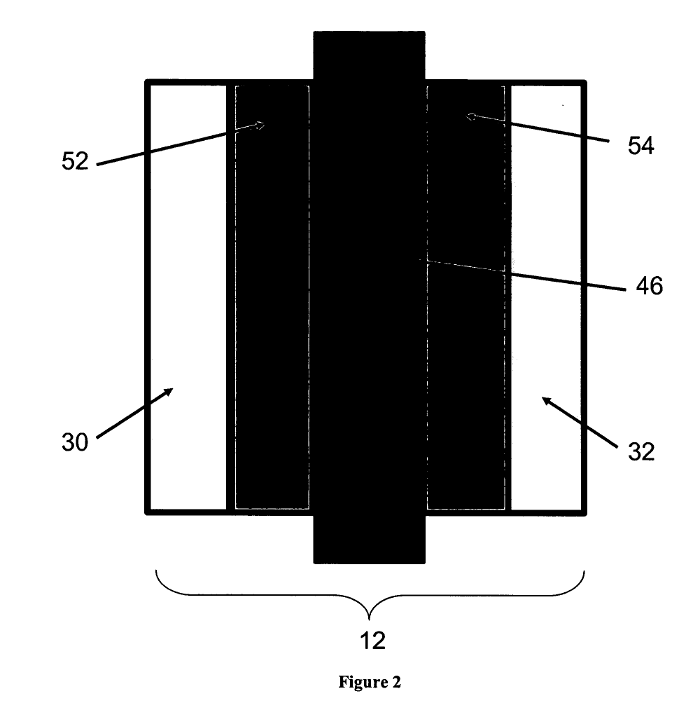

FIG. 1 shows a fuel cell 10 that has incorporated into it an MEA 12, in accordance with one embodiment of the present invention. MEA 12 includes an inventive ion exchange membrane 46 (shown in greater detail in FIG. 2). However, it should be noted that the application of inventive membranes are not limited to the fuel cell configuration as shown in FIG. 1, rather they can also be effectively employed in conventional fuel cell applications described in U.S. Pat. Nos. 5,248,566 and 5,547,777, which are incorporated by reference herein for all purposes. Furthermore, several fuel cells may be connected in series by conventional techniques to create a fuel cell stack, which contains at least one of the inventive membranes.

As shown in FIG. 1, MEA 12 is flanked by anode and cathode structures. On the anode side, fuel cell 10 includes an endplate 14, graphite block or bipolar plate 18 with openings 22 to facilitate gas distribution, gasket 26, and anode current collector 30. On the cathode side, fuel cell 10 similarly includes an endplate 16, graphite block or bipolar plate 20 with openings 24 to facilitate gas distribution, gasket 28, and cathode current collector 32. Anode current collector 30 and cathode current collector 32 are typically made of a porous material such as carbon cloth or carbon paper and may optionally include a carbon particulate layer adjacent to the porous material.

Endplates 14 and 16 are connected to external load circuit 50 by leads 31 and 33, respectively. External circuit 50 can be comprised of any conventional electronic device or load such as those described in U.S. Pat. Nos. 5,248,566, 5,272,017, 5,547,777, and 6,387,556, which are incorporated herein by reference for all purposes. The electrical components can be hermetically sealed by techniques well known to those skilled in the art.

During operation, in fuel cell 10 of FIG. 1, fuel from fuel source 37 (e.g., container or ampule) diffuses through the anode and oxygen from an oxygen source 39 (e.g., container, ampule, or air) diffuses through a catalyst dispersion on the cathode side of the MEA. The chemical reactions at the MEA generate electricity that is transported to the external circuit. Hydrogen fuel cells use hydrogen for fuel and oxygen (either pure or in air) as the oxidant. In direct methanol fuel cells, the fuel is liquid methanol.

Endplates 14 and 16 are made from a relatively dimensionally stable material. Preferably, such material includes one selected from a group consisting of metal and metal alloy. Bipolar plates 18 and 20 are typically made from any conductive material selected from a group consisting of graphite, carbon, metal, and metal alloys. Gaskets, 26 and 28 are typically made of any material selected from a group consisting of Teflon®, fiberglass, silicone, and rubber.

FIG. 2 shows a side-sectional view of MEA 12, which is incorporated into fuel cell 10 of FIG. 1. As shown in this embodiment, MEA 12 includes an ion exchange membrane 46 that is flanked by an anode catalyst dispersion 52 and a cathode catalyst dispersion 54. Each of 52 and 54 are made of carbon based particulate material with some type of catalyst material dispersed throughout. Adjacent to catalyst dispersions 52 and 54 are anode current collector 30, and cathode current collector 32 respectively. Disposed between catalyst dispersions 52 and 54 is ion exchange membrane 46.

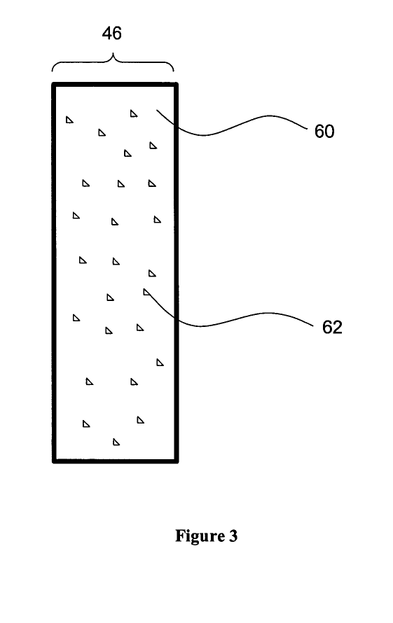

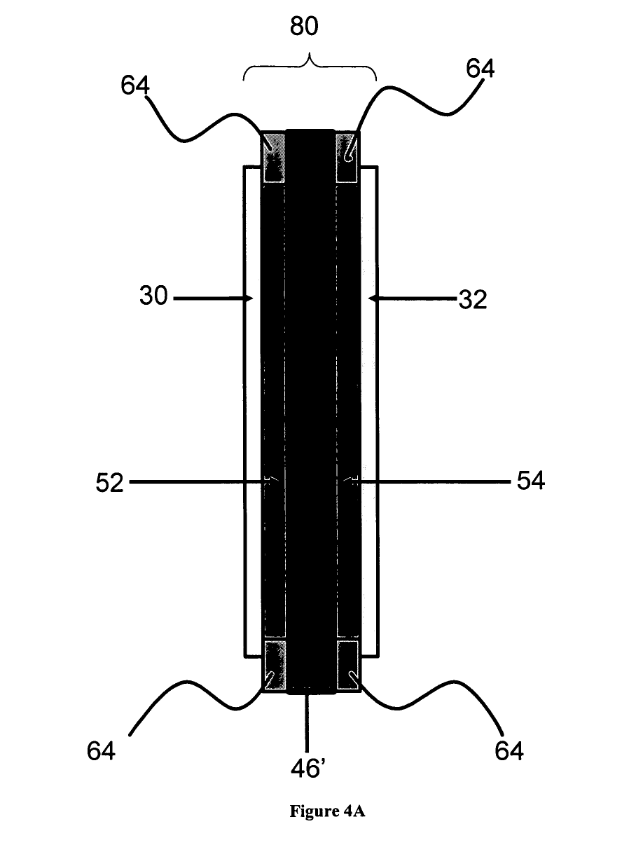

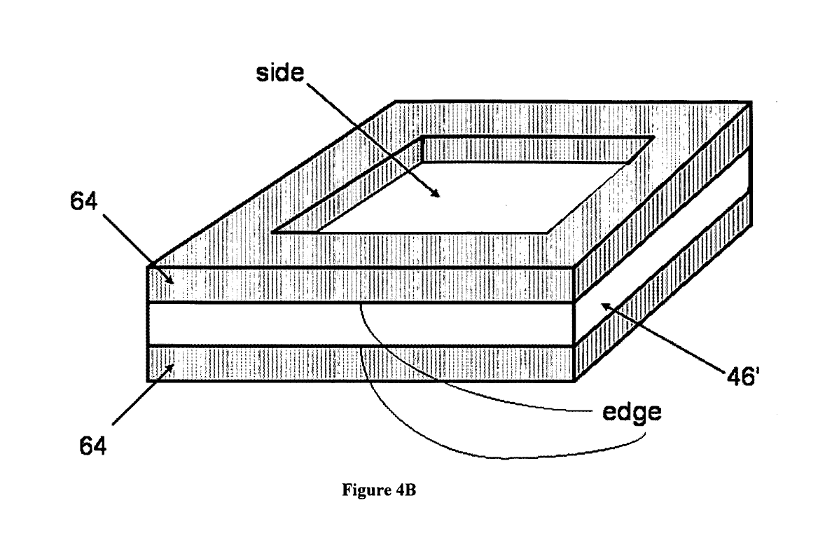

Ion exchange membranes of the present invention can comprise of two or more components. Preferred embodiments of the inventive ion exchange membranes include, for example, one component dispersed in another component, as shown in FIG. 3, which is described in greater detail below. Alternatively, other preferred embodiments of the inventive exchange membranes include, for example, one layer disposed adjacent another layer, as shown in FIGS. 4A, 5A and 6, which are also described in greater detail below.

FIG. 3 shows a detailed illustration of an ion exchange membrane 46 integrated into MEA 12 of FIG. 2. Ion exchange membrane 46 primarily includes a first component 60, which includes a polymer electrolyte composition described in great detail in a pending patent application (Attorney Docket # 372584/349928) filed on Oct. 26, 2004, which is incorporated herein by reference for all purposes. Dispersed in first component 60 is a second component 62, which is known as filler to those skilled in the art. Typical amounts of filler present in ion exchange membrane 46 varies depending on the desired composition of ion exchange membrane 46. However, the amount of filler found in ion exchange membrane 46 can range from about 0.01 wt. % to about 50 wt. % and more preferably from about 0.5 wt. % to about 10 wt. %.

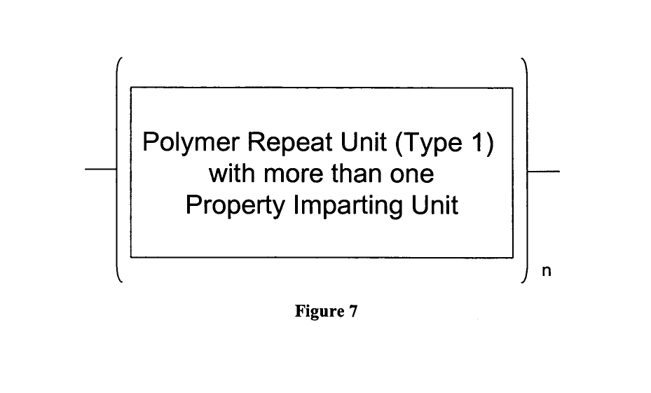

FIG. 7 shows the structure of a polymer electrolyte composition, according to one embodiment of the present invention. This composition is integrated into ion exchange membrane 46 and includes at least one polymer repeat unit, which has more than one property imparting unit. The term “property imparting unit,” as it is used with respect to this disclosure, refers to a chemical group or moiety, which imparts a desired property to the ultimately formed polymer electrolyte. Such a desired property of the resulting polymer electrolyte, in most instances, also proves beneficial to ion exchange membrane 46. According to the present invention, the polymer repeat unit can be synthesized to have a certain property of interest by including in its composition an appropriate property imparting unit. The property imparting unit can be, for example, a conductivity imparting unit, a stability imparting unit, or any combination thereof.

A conductivity imparting unit can be any unit that imparts the polymer repeat unit or the ultimately produced ion exchange membrane 46 (which includes the polymer electrolyte) with a certain desired conductivity. In a preferred embodiment of the present invention, however, a conductivity imparting unit includes at least one member selected from a group consisting of sulfonic acid, derivatives of sulfonic acid, phosphonic acid, derivatives of phosphonic acid, carboxylic acid, derivatives of carboxylic acid, heterocycles such as imidazole, benzimidazole, pyrazole and any combination thereof.

A stability imparting unit can be any unit that imparts to the polymer repeat unit or ion exchange membrane 46 with a certain desired stability. In a preferred embodiment of the present invention, however, a stability imparting unit includes at least one member selected from a group consisting of crosslinking agents, antioxidizing agents, blocking agents and any combination thereof. Representative crosslinking agents include at least one member selected from a group consisting of acrylates, methacrylates, alkynes, epoxides, amines, amine derivatives, fumarates, maleates, maliemides and alkenes, which in turn include allyls, substituted allyls, vinyls and substituted vinyls, and any combination thereof. Representative antioxidizing agents include at least one member selected from a group consisting of metal chelating groups, radical absorbing groups, peroxide decomposition groups such as phosphates, phosphate esters, phosphonic acid, derivatives of phosphonic acid and EDTA and any combination thereof. Representative blocking agents include at least one member selected from a group consisting of branched hydrocarbon chains, long hydrocarbon chains, branched fluorocarbon chains, long fluorocarbon chains and any combination thereof.

Both conductivity and stability imparting units may or may not include a delinking agent. In those embodiments where a delinking agent is used, the delinking agent may vary in composition but include at least one member selected from a group consisting of C—C bond, CH₂, CH₃, CF₂, CF₃, Si, O, S, functional groups, aromatic residues and any combination thereof. In addition to the delinking agent, the conductivity imparting unit includes a member selected from a group consisting of sulfonic acid, derivatives of sulfonic acid, phosphonic acid, derivatives of phosphonic acid, carboxylic acid, derivatives of carboxylic acid, heterocycles, such as imidazole, benzimidazole and pyrazole, and any combination thereof. Similarly, in addition to the delinking agent, the stability imparting unit includes at least one member selected from the above described group consisting of crosslinking agents, antioxidizing agents, blocking agents and any combination thereof.

Filler 62 shown in FIG. 3 can be any material that imparts the resulting ion exchange membrane 46 improved performance characteristics. Fillers are typically added to the casting solutions (consisting of ion exchange polymer material) prior to casting. Once cast, the fillers can be discrete, separate entities dispersed within the resulting ion exchange membrane 46. Fillers, depending on the type, may improve several areas of ion exchange membrane performance including, operational temperature, conductivity, mechanical strength, and chemical resistance (e.g., oxidative and others). In preferred embodiments of the present invention, filler 62 is at least one member selected from a group consisting of a fibers, inorganic additives and organic additives. In such preferred embodiments, fibers include at least one member selected from a group consisting of silica, alumina, polyethylene (PE), polypropylene (PP), polytetrafluoroethylene (PTFE), polyvinylidene fluoride (PVDF), polysulfones, polyphenylenes, polyetherketone (PEK), polyetheretherketone (PEEK), polyetherketone-ketone (PEKK), polyetheretherketone-ketone (PEEKK), polyether sulfone (PES), polybenzimidazole (PBI), liquid crystal polymer (LCP), polycarbonate, polyurethane, and polysiloxane. Representative inorganic additives include at least one member selected from a group consisting of clays, zeolites, heteropoly acids, phosphonic acids, metal oxides, transition metals, transition metal derivatives, and phosphate materials. Representative organic additives include at least one member selected from a group consisting of carboxylic acids, organophosphorous compounds, hindered phenols, and thioesters.

FIG. 4A shows an MEA 80 having integrated into it a perimeter strengthening material 64 and ion exchange membrane 46′. MEA components 30, 32, 50 and 54 of FIG. 4A are the same as those shown in FIG. 2. Perimeter strengthening material 64 can be any material that strengthens the perimeter of ion exchange membrane 46′. In preferred embodiments of the inventive MEAs, however, perimeter strengthening material 64 includes at least one member selected from a group consisting of PE, PP, PTFE, PVDF, polysulfone (PSU), polyimide (PI), polyphenylene, polyphenylene oxide (PPO), polyphenylene sulfoxide (PPSO), polyphenylene sulfide (PPS), polyparaphenylene (PPP), polyphenylquinoxaline (PPQ), polyarylketone (PK), PEK, PEEK, PEKK, PEEKK polyetherketoneetherketone-ketone (PEKEKK), PES, polybenzazole (PBZ), polybenzimidazole (PBI), polyamid polymers, LCP, polyvinyl chloride (PVC), polycarbonate, Nylon, Nylon 6,6, polyurethane and polysiloxane. The present invention recognizes that the presence of a perimeter strengthening material around an ion exchange membrane prolongs the longevity of that membrane and, therefore, provides a fuel cell with a much longer life span than fuel cells with conventional membranes. MEAs used in conventional fuel cells do not contemplate using a perimeter strengthening material. Preferred embodiments of the present invention provide a perimeter strengthening material that is resistant to oxidative, hydrolytic and thermal degradation.

FIG. 4B is a perspective view of ion exchange membrane 46′ surrounded by perimeter strengthening material 64, both of which are shown in FIG. 4A and described above in great detail.

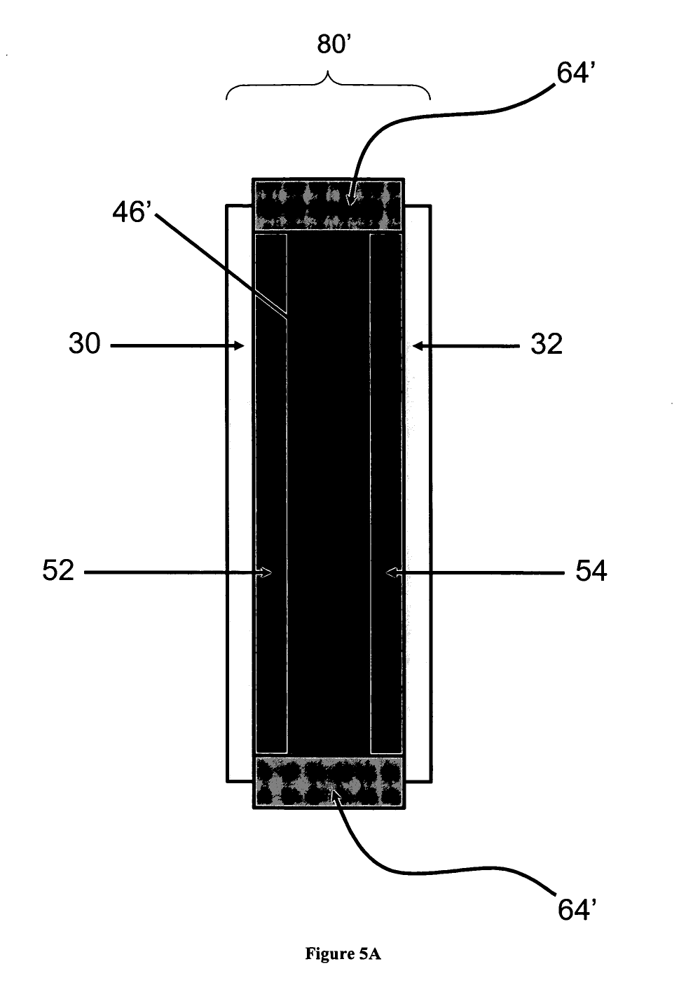

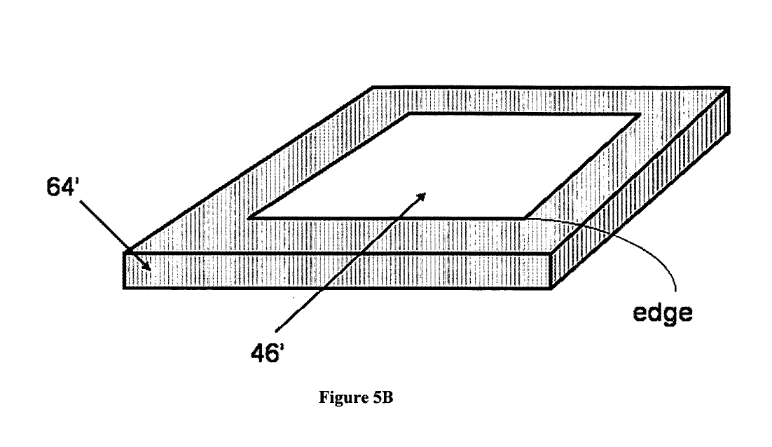

FIG. 5A shows an MEA 80′ having integrated into it a perimeter strengthening material 64′ and ion exchange membrane 46′. MEA components 30, 32, 50 and 54 of FIG. 5A are the same as those shown in FIG. 2. Perimeter strengthening material 64′ can be any material that strengthens the perimeter of ion exchange membrane 46′. In preferred embodiments of the inventive membrane electrode assemblies, however, perimeter strengthening material 64′ is made from the same materials as its counterpart shown in FIG. 4A. It is important for the reader to note that the thickness of the perimeter strengthening material 64′, may or may not be the same thickness as the ion exchange membrane 46′. FIG. 5B, similar to FIG. 4B, is a perspective view of ion exchange membrane 46′ surrounded by perimeter strengthening material 64′. The difference between the embodiments of FIGS. 4B and 5B is that in FIG. 5B, the perimeter strengthening material 64′, surrounds portions of ion exchange membrane 46′ by wrapping around its edges. In the embodiment of FIG. 4B, the perimeter strengthening material 64 adheres to a perimeter boundary of two sides of ion exchange membrane 46′.

It is important to note that ion exchange material 46′ is not limited to include the above-described polymer electrolyte composition as in the case of ion exchange material 46 shown in FIG. 3. Rather, ion exchange material 46′ can be a conventional ion exchange material that is well known to those skilled in the art or be the above-described polymer electrolyte composition having the appropriate property imparting units.

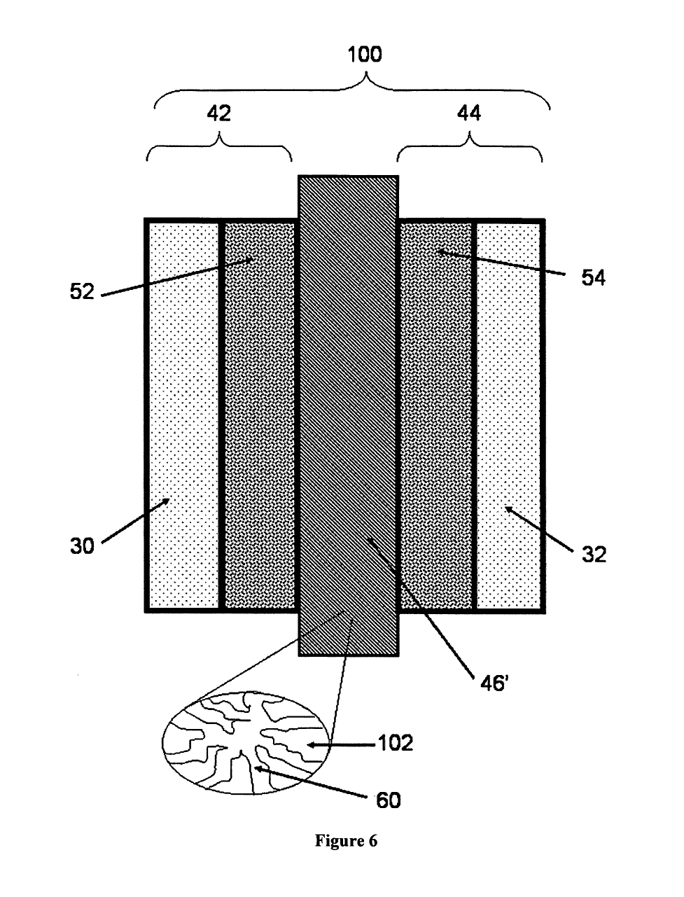

FIG. 6 shows another preferred embodiment of an MEA 100 including an ion exchange material 60 impregnated into a porous matrix 102. The combination of ion exchange material 60 and porous matrix 102 make up the ion exchange membrane 46′. In additional embodiments, porous matrix 102, may have at least one filler 62, impregnated within its porous matrix. Ion exchange material 60, includes at least one polymer repeat unit, which has more than one property imparting unit and is described in great detail in a pending patent application (Attorney Docket # 372584/349928) filed on Oct. 26, 2004. MEA components 30, 32, 50, 54 of FIG. 6 are the same as those shown in FIG. 2. The porous matrix 102, can be at least one member selected from a group consisting of fluorinated polymer, PE, PP, PTFE, PVDF, polysulfone (PSU), polyimide (PI), polyphenylene, polyphenylene oxide (PPO), polyphenylene sulfoxide (PPSO), polyphenylene sulfide (PPS), polyparaphenylene (PPP), polyphenylquinoxaline (PPQ), polyarylketone (PK), polyetherketone (PEK), polyetheretherketone (PEEK), polyetherketone-ketone (PEKK), polyetheretherketone-ketone (PEEKK) polyetherketoneetherketone-ketone (PEKEKK), polyether sulfone (PES), polybenzazole (PBZ), polybenzimidazole (PBI), polyamid polymers, liquid crystal polymer (LCP), polyvinyl chloride (PVC), polycarbonate, Nylon, Nylon 6,6, polyurethane, and polysiloxane.

Inventive MEA embodiments in FIGS. 4A, 5A and 6 can be substituted for MEA 12 (shown in FIG. 2) in fuel cell 10 of FIG. 1. Such fuel cells according to the present invention enjoy prolonged lifetimes and are relatively more stable.

The present invention also provides inventive methods of making the novel MEAs described above. In accordance with one embodiment of the present invention, a process of making MEA shown in FIG. 2 includes preparing a solution of a polymer electrolyte composition, which contains at least one type of a polymer repeat unit having attached thereto more than one property imparting unit (see FIG. 7). The property imparting unit includes at least one member selected from a group consisting of a conductivity imparting unit and a stability imparting unit. For more information on the various ways such polymer repeat units can be formed, reference can be made to above-mentioned pending patent application (Attorney Docket # 372584/349928). At this stage, the polymer electrolyte solution is combined with a performance enhancing component.

A performance enhancing component can, but need not, provide similar benefits as a property imparting unit of the polymer electrolyte composition. More importantly, when a performance enhancing component and a property imparting unit provide similar advantages, they are beneficial at different levels. A performance enhancing component augments the performance of the ion exchange membrane from a macroscopic point of view. For example, a fiber filler material may strengthen and support the ion exchange material helping it to resist chemical and mechanical degradation at a macro level. In stark contrast, a property imparting unit benefits the performance of the ion exchange membrane from a microscopic point of view, or alternatively at molecular level. For example, a stability imparting unit may intrinsically stabilize the ion exchange membrane and build resistance to attack from electrochemical cell byproducts at a molecular level.

Next, the process includes casting on a support assembly, such as carrier plate, the solution containing the performance enhancing component. Next, drying commences to form an ion exchange membrane (e.g., ion exchange membrane 46 shown in FIG. 2). In alternative embodiments, of the inventive processes, the casting and drying step is carried out by web coating the solution containing the performance enhancing component. Furthermore, as mentioned above, in preferred embodiments, the inventive ion exchange membranes include a filler.

In accordance with another embodiment of the present invention, a process of making MEA (e.g., shown in FIG. 4A) includes obtaining an ion exchange layer (similar to ion exchange membrane 46′ of FIGS. 4A and 5A). The ion exchange layer can be a conventionally known layer or in the alternative can be made using a polymer electrolyte composition described in pending patent application (Attorney Docket # 372584/349928). Next, the process includes fabricating a performance enhancing layer (similar to layer 64 or 64′ as shown in FIGS. 4A and 5A, respectively) around at least a portion of a perimeter of the ion exchange layer to form an ion exchange membrane. To form the MEA shown in FIG. 4A, the electrodes are assembled adjacent to membrane 46 using a pressing technique or by a direct application process described in pending patent application (Attorney Docket # 372584/00401) and filed on May 28, 2004, which is incorporated herein by reference for all purposes. Other application methods to form an MEA include electrodeposition, screen printing, flexographic printing, decal methods, or ink jet printing. The above-mentioned step of fabricating a perimeter strengthening material around an ion exchange layer includes printing a perimeter strengthening material to an ion exchange layer, casting a perimeter strengthening material to an ion exchange layer, hot pressing an ion exchange layer and a performance enhancing layer, laminating a performance enhancing layer to an ion exchange layer, molding an ion exchange layer and a performance enhancing layer and, adhering an ion exchange layer and a performance enhancing layer. During the fabrication step, a performance enhancing layer of an appropriate shape, as shown in FIGS. 4A, 4B, 5A and 5B are used. It is important to note, however, that other configurations of performance enhancing layer may be used. By way of example, a performance enhancing layer is made from a perimeter strengthening material described above using techniques well known to those skilled in the art.

In accordance with yet another embodiment of the present invention, a process of making the MEA shown in FIG. 6 includes preparing a solution of a polymer electrolyte composition as mentioned above. This composition includes at least one type of a polymer repeat unit, which has attached to it more than one property imparting unit. The property imparting unit includes at least one member selected from a group consisting of a conductivity imparting unit and a stability imparting unit. Next, the process includes impregnating the solution into a porous material. The porous material can be porous matrix 102, which is shown in FIG. 6 and is described above.

The ion exchange membrane 60 of FIG. 6 is formed when the solution undergoes drying. MEA 100 of FIG. 6 is formed using ion exchange membrane 60 using techniques described above.

### EXAMPLE 1

This example describes the synthesis, according to one embodiment of the present invention, of an exemplar ionomer. 4,4′-difluoro 3,3′-di sodium sulfonate salt of phenyl sulfone (about 27.50 g, about 0.06 mol) and 4-fluorophneyl sulfone (about 35.56 g, about 0.014 mol) was reacted with 1,4-di(4-hydroxy phenyl) butane (about 7.26 g, about 0.03 mol) and 4,4′-biphenol (about 31.66 g, about 0.017 mol) in the presence of potassium carbonate (about 31.79 g, about 0.023 mol) under a dry nitrogen atmosphere in a round bottom flask equipped with nitrogen inlet and a Dean-Stark trap using DMSO (about 450 mL) and benzene. After refluxing/recycling of benzene or toluene at about 150° C. for about 4 hours, all the benzene was removed and the heating was continued for another about 10 hrs at about 160° C. The mixture was cooled and additional DMSO (about 200 mL) was added to the reaction mixture. The viscous solution was filtered and then poured into a large excess of water in order to obtain a transparent white polymer. The resulting polymer was washed, filtered and dried.

### EXAMPLE 2

This example describes the synthesis, according to one embodiment of the present invention, of an exemplar ionomer of the present invention. 4-fluorophenyl sulfone (about 25.43 g, about 0.1 mol) was reacted with 3,3-di(sodium-3-(2-methyl propyl) sulfonate)-4,4′-biphenol (IUPAC name: di sodium salt of 3-[4,4′-dihydroxy-3′(2-methyl-3-sulfo-propyl)-biphenyl-3-yl]-2-methyl-propane-1-sulfonic acid) (about 20.01 g, about 0.04 mol) and 4,4′-biphenol (about 11.17 g, about 0.06 mol) in the presence of potassium carbonate (about 15.89 g, about 0.115 mol) under a dry nitrogen atmosphere in a round bottom flask equipped with nitrogen inlet and a Dean-Stark trap using DMSO (about 300 mL) and benzene. After refluxing/recycling of benzene or toluene at about 150° C. for about 4 hours, all the benzene was removed and the heating was continued for another about 6 hrs at about 160° C. The mixture was cooled and additional DMSO (about 100 mL) was added to the reaction mixture. The viscous solution was filtered and then poured into a large excess of water in order to obtain a transparent white polymer. The resulting polymer was washed, filtered and dried.

### EXAMPLE 3

This example describes a method of making membranes, according to preferred embodiments of the present invention. About 50 g of polymer was dissolved in about 500 mL of an aprotic solvent such as DMSO, NMP, DMF, DMAc or mixtures thereof and the resulting solution was pressure filtered using a low micron pore size filter. If needed, the polymer concentration in the solution was then adjusted to about 20 wt. % by evaporating the aprotic solvent using a roto-evaporator. The membranes were prepared by web casting the resulting polymer solution and was dried at about 100° C. for about 3 hrs and then at about 130° C. for about 6 hrs. In other modifications of this example, the membranes are dried for longer and shorter periods of time.

### EXAMPLE 4

This example describes an exemplar method of incorporating a filler into an ion exchange membrane. About 50 g of polymer was dissolved in about 500 mL of an aprotic solvent such as DMSO, NMP, DMF, DMAc or mixtures thereof and the resulting solution was pressure filtered using a low micron pore size filter. In preferred embodiments of this invention, the polymers in the solution are the ones mentioned in Examples 1 and 2 are used. Next, about 2.5 g of a filler such as MnO₂ (particle size<about 5 microns) are added to the polymer solution and mixed for about 12 hrs at room temperature, while sonicating periodically. The resulting mixture was then adjusted to about 20 wt. % polymer in solvent by evaporating the aprotic solvent using a roto-evaporator. The resulting solution was then used to form membranes similarly to those prepared in Example 3 or the solution may be incorporated into a porous matrix (for more information on incorporation, see example 5 below).

### EXAMPLE 5

This example describes the preparation of a reinforced membrane. A micro porous substrate made of polyethylene, PTFE, PP, or any combination thereof was stretched and held in place as it went through several treatments. The substrate was first infiltrated (or wetted) with an alcohol such as methanol, ethanol, isopropanol, or mixtures thereof. Next the substrate is treated with an aprotic solvent such as DMSO, NMP, DMF, DMAc or mixtures thereof. After such treatment, the substrate was infiltrated with a polymer solution and the resulting reinforced membrane is smoothed to a desired thickness. In preferred embodiments of the invention, the polymers in the solution are the ones mentioned in Examples 1 and 2 above. The membrane was then dried under various conditions and protonated to yield an ion exchange membrane described previously.

### EXAMPLE 6

This example describes the preparation, according to one embodiment of the present invention of a MEA with a perimeter strengthening material. An ion exchange layer (membrane) is placed between two layers of perimeter strengthening materials. Preferred materials include<about 200 micron thick layers of PE, PP, PTFE, PVDF, PSU, PI, polyphenylene, or any combination thereof. Additionally, the perimeter strengthening material has an adhesive layer that is pressure or thermally sensitive. The perimeter reinforcing material prior to the sandwiching operation is cut to have dimensions to match the required active area of catalyst. Next, the perimeter sealing material is joined to the membrane by hot pressing for about 120° C. at about 3 minutes with about 400 kg load. The catalyst containing layers are applied directly to the ion exchange layer within the perimeter strengthening layer. Typical electrocatalyst loadings are about 0.1 to about 1 mg/cm² on both the anode and the cathode. After applying, the catalyst layers are dried by placing in a vacuum oven at a temperature of about 90° C. for about half an hour to remove a majority of the catalyst ink solvent.

After drying, the resulting MEA is hot pressed at about 120° C. for about 3 minutes at a pressure of about 30 kg/cm². After the hot pressing, the MEA is placed in 0.5 M sulfuric acid-water solution for about half an hour at about 60° C. The MEA is then rinsed and soaked in deionized water for about 15 minutes. Next, the MEA is placed between two current collectors (otherwise known as gas diffusion layers) and pressed at about 130° C. for about 3 minutes at about 30 kg/cm².

### EXAMPLE 7

This example describes the preparation, according to one embodiment of the present invention, of an MEA with a perimeter strengthening material using catalyst coated carbon layers. First, the perimeter sealing materials and ion exchange layer (membrane) are attached as described in Example 6. Next or contemporaneously, the catalyst layers are applied directly to a porous carbon layer. Typical electrocatalyst loadings are about 0.1 mg/cm² to about 1 mg/cm² on both the anode and the cathode. The final step in MEA assembly entails sandwiching the ion exchange layer and perimeter sealing materials between porous carbon layers containing catalyst (catalyst side adjacent to the ion exchange membrane and pressing at about 130° C. for about 3 minutes at about 30 kg/cm².

Although the present invention is described in terms of fuel cell applications, those skilled in the art will recognize that the inventive structures and techniques described herein can be used for other electrochemical applications.

What is claimed is:

1. An ion exchange membrane for use in an electrochemical cell, comprising:
a first layer capable of conducting ions when placed between two electrodes of said electrochemical cell; and
a second layer disposed around at least a portion of said first layer, wherein said second layer is made from a perimeter strengthening material, such that said second layer strengthens at least a portion of a perimeter boundary of said first layer.

2. The ion exchange membrane of claim 1, wherein said first layer includes a proton exchange membrane.

3. The ion exchange membrane of claim 1, further comprising a filler which includes at least one member selected from of a group consisting of fibers, inorganic additives and organic additives.

4. The ion exchange membrane of claim 3, wherein said fibers include at least one member selected from a group consisting of silica, alumina, polyethylene (PE), polypropylene, polytetrafluoroethylene (PTFE), polyvinylidene fluoride (PVDF), polysulfones, polyphenylenes, polyetherketone (PEK), polyetheretherketone (PEEK), polyetherketone-ketone (PEKK), polyetheretherketone-ketone (PEEKK), polyether sulfone (PES), polybenzimidazole (PBI), liquid crystal polymer (LCP), polycarbonate, polyurethane, and polysiloxane.

5. The ion exchange membrane of claim 3, wherein said inorganic additives include at least one member selected from a group consisting of clays, zeolites, heteropoly acids, phosphonic acids, metal oxides, transition metals, transition metal derivatives, and phosphate materials.

6. The ion exchange membrane of claim 3, wherein said organic additives include at least one member selected from a group consisting of carboxylic acids, organophosphorous compounds, hindered phenols, and thioesters.

7. The ion exchange membrane of claim 1, further comprising a porous matrix which includes at least one member selected from a group consisting of fluorinated polymer, PE, polypropylene, PTFE, PVDF, polysulfone (PSU), polyimide (PI), polyphenylene, polyphenylene oxide (PPO), polyphenylene sulfoxide (PPSO), polyphenylene sulfide (PPS), polyparaphenylene (PPP), polyphenylquinoxaline (PPQ), polyarylketone (PK), polyetherketone (PEK), polyetheretherketone (PEEK), polyetherketone-ketone (PEKK), polyetheretherketone-ketone (PEEKK) polyetherketoneetherketone-ketone (PEKEKK), polyether sulfone (PES), polybenzazole (PBZ), polybenzimidazole (PBI), polyamid polymers, liquid crystal polymer (LCP), polyvinyl chloride (PVC), polycarbonate, Nylon, Nylon 6,6, polyurethane, and polysiloxane.

8. The ion exchange membrane of claim 1, wherein said perimeter strengtheners includes at least one member selected from a group consisting of PE, polypropylene, PTFE, PVDF, polysulfone (PSU), polyimide (PI), polyphenylene, polyphenylene oxide (PPO), polyphenylene sulfoxide (PPSO), polyphenylene sulfide (PPS), polyparaphenylene (PPP), polyphenylquinoxaline (PPQ), polyarylketone (PK), PEK, PEEK, PEKK, PEEKK polyetherketoneetherketone-ketone (PEKEKK), PES, polybenzazole (PBZ), polybenzimidazole (PBI), polyamid polymers, LCP, polyvinyl chloride (PVC), polycarbonate, Nylon, Nylon 6,6, polyurethane, and polysiloxane.

9. An ion exchange membrane for use in an electrochemical cell, comprising:
a first component; and
a second component which includes at least one member selected from a group consisting of filler, porous matrix and a perimeter strengthening material, wherein said first component contains a polymer electrolyte composition which includes at least one type of a polymer repeat unit that has more than one property imparting unit, said property imparting unit includes at least one member selected from a group consisting of a conductivity imparting unit and a stability imparting unit.

10. The ion exchange membrane of claim 9, wherein said polymer repeat unit further comprising a delinking agent attached to at least one of said property imparting unit, wherein said delinking agent includes at least one member selected from a group consisting of C—C bond, CH₂, CH₃, CF₂, CF₃, Si, O, S, functional groups aromatic residues and any combination thereof.

11. The ion exchange membrane of claim 9, wherein said conductivity imparting unit includes an ion conducting moiety which is at least one member selected from a group consisting of sulfonic acid, derivatives of sulfonic acid, phosphonic acid, derivatives of phosphonic acid, carboxylic acid, derivatives of carboxylic acid, heterocycles such as imidazole, benzimidazole, pyrazole and any combination thereof.

12. The ion exchange membrane of claim 9, wherein said stability imparting unit includes a crosslinking agent which is at least one member selected from the group consisting of acrylates, methacrylates, alkenes, alkynes, epoxides, amines, amine derivatives, fumarates, maleates, maliemides and any combination thereof.

13. The polymer electrolyte composition of claim 9, wherein said stability imparting unit includes an antioxidizing agent which is at least one member selected from the group consisting of phosphates, phosphate esters, phosphonic acid, derivatives of phosphonic acid, metal chelating agents and any combination thereof.

14. The polymer electrolyte composition of claim 9, wherein said stability imparting unit includes a blocking agent which is at least one member selected from the group consisting of branched hydrocarbon chains, long hydrocarbon chains, bulky hydrocarbon groups, branched fluorocarbon chains, long fluorocarbon chains, bulky fluorocarbon groups and any combination thereof.

15. A process of making an ion exchange membrane, comprising:
preparing a solution of a polymer electrolyte composition including at least one type of a polymer repeat unit having attached thereto more than one property imparting unit, said property imparting unit includes at least one member selected from a group consisting of a conductivity imparting unit and a stability imparting unit;
adding to said solution a performance enhancing component;
casting on a support assembly said solution containing said performance enhancing component; and
drying said solution to form an ion exchange membrane which has dispersed within it said performance enhancing component.

16. The process of claim 15, wherein said casting and said drying include web coating said solution containing said performance enhancing unit.

17. The process of claim 15, wherein in said adding, said performance enhancing component is a filler which is at least one member selected from a group consisting of fibers, inorganic additives and organic additives.

18. A process of making an ion exchange membrane, comprising:
obtaining an ion exchange layer including at least one type of a polymer repeat unit that has more than one property imparting unit, said property imparting unit includes at least one member selected from a group consisting of a conductivity imparting unit and a stability imparting unit;
fabricating around at least a portion of a perimeter of said ion exchange layer a performance enhancing layer to form said ion exchange membrane.

19. The process of claim 18, wherein said fabricating includes hot pressing said ion exchange layer and said performance enhancing layer.

20. The process of claim 18, wherein said fabricating includes laminating said ion exchange layer and said performance enhancing layer.

21. The process of claim 18, wherein said fabricating includes molding said performance enhancing layer to said ion exchange layer.

22. The process of claim 18, wherein said fabricating includes adhering said ion exchange layer to said performance enhancing layer.

23. The process of claim 18, wherein said performance enhancing layer is a perimeter strengthening material.

24. A process of making an ion exchange membrane, comprising:
preparing a solution of a polymer electrolyte composition including at least one type of a polymer repeat unit having attached thereto more than one property imparting unit, said property imparting unit includes at least one member selected from a group consisting of a conductivity imparting unit and a stability imparting unit;
impregnating said solution into a porous material; and
drying said solution to form an ion exchange membrane.

25. The process of claim 24, wherein said porous material includes at least one member selected from the group consisting of fluorinated polymer, polyethylene (PE), polypropylene, polytetrafluoroethylene (PTFE), polyvinylidene fluoride (PVDF), polysulfone (PSU), polyimide (PI), polyphenylene, polyphenylene oxide (PPO), polyphenylene sulfoxide (PPSO), polyphenylene sulfide (PPS), polyparaphenylene (PPP), polyphenylquinoxaline (PPQ), polyarylketone (PK), polyetherketone (PEK), polyetheretherketone (PEEK), polyetherketone-ketone (PEKK), polyetheretherketone-ketone (PEEKK) polyetherketoneetherketone-ketone (PEKEKK), polyether sulfone (PES), polybenzazole (PBZ), polybenzimidazole (PBI), polyamid polymers, liquid crystal polymer (LCP), polyvinyl chloride (PVC), polycarbonate, Nylon, Nylon 6,6, polyurethane, and polysiloxane.

26. A membrane electrode assembly, comprising:
a cathode;
an anode; and
an ion exchange membrane including
a first layer capable of conducting ions when placed between said cathode and said anode, and
a second layer disposed around at least a portion of said first layer, wherein said second layer is made from a perimeter strengthening material, such that said second layer strengthens at least a portion of a perimeter boundary of said first layer.

27. A membrane electrode assembly, comprising:
a cathode;
an anode; and
an ion exchange membrane including
a first component, and
a second component which includes at least one member selected from a group consisting of filler, porous matrix and a perimeter strengthening material, wherein said first component contains a polymer electrolyte composition which includes at least one type of a polymer repeat unit that has more than one property imparting unit, said property imparting unit includes at least one member selected from a group consisting of a conductivity imparting unit and a stability imparting unit.
